(19) United States
(12) Patent Application Publication
(10) Pub. No.: US 2016/0183319 A1
(43) Pub. Date: Jun. 23, 2016

(54) METHOD AND APPARATUS FOR SUPPORTING DEVICE TO DEVICE COMMUNICATION SERVICE IN WIRELESS COMMUNICATION SYSTEM

(71) Applicant: LG ELECTRONICS INC.,, Seoul (KR)

(72) Inventors: Ilmu Byun, Seoul (KR); Jaehoon Chung, Seoul (KR); Eunjong Lee, Seoul (KR); Hyeyoung Choi, Seoul (KR); Heejeong Cho, Seoul (KR); Genebeck Hahn, Seoul (KR)

(21) Appl. No.: 14/909,574

(22) PCT Filed: Aug. 8, 2014
(86) PCT No.: PCT/KR2014/007361

§ 371 Date: Feb. 2, 2016

Related U.S. Application Data
(60) Provisional application No. 61/863,459, filed on Aug. 8, 2013.

(51) Int. Cl. H04W 76/02; H04W 72/04

(52) U.S. Cl. CPC H04W 76/023; H04W 72/04

(57) ABSTRACT

The present invention provides a method and apparatus for supporting device-to-device (D2D) communication in a wireless communication system. The present invention obtains information on time and resources required for signal transmission of corresponding user equipment (UE), estimates transmission time of the signal transmission by using the information on time and resources, and checks propagation delay by comparing the estimated transmission time with reception time of a signal transmitted from an actual corresponding UE. The present invention compares the checked propagation delay with predetermined reference values for converting to D2D communication and determines whether to perform D2D communication. Also, the determining D2D communication may include determining conversion to D2D communication by taking account of a channel state of a received signal.

### BACKGROUND OF THE INVENTION

1. Field of the Invention

The present invention relates to a wireless communications, and more particularly, a method and apparatus for establishing a link for device-to-device (D2D) communication in a wireless communication system supporting device-to-device communication.

2. Related Art

A long term evolution (LTE) system, the next generation wireless communication system, is fully commercialized today. The LTE system is being spread more quickly once the needs for a system capable of ensuring mobility of users and providing in high quality not only a voice service but also a large capacity service with respect to a user requirement were recognized. The LTE system is characterized by low transmission latency, high transmission rate, high system capacity, and improved coverage.

Meanwhile, taking account of requirements of service providers who provide services to the users, performance enhancement through improvement of the existing radio access or network, and an investment recovery plan for an existing wireless communication system, the LTE system either maintains compatibility with the 2G communication system employing global system for mobile communications (GSM) based on time division multiple access (TDMA) technology and the 3G communication system employing universal mobile telecommunication system (UMTS) based on wideband code division multiple access (W-CDMA) technology or evolves in the form of a system coexisting with the 2G and the 3G communication systems.

In particular, along with the advent of smart phones and tablet-type personal computers (PCs), users of these communication devices are in need of a service through which the users can obtain or share desired information at any place and at any time.

It is still true, however, that providing trivial but useful, real-time information in an effective way for the users in everyday environments cannot be easily realized by a wireless communication system due to its inherent complexity or time delay. Meanwhile, device-to-device (D2D) communication is getting more public attention, which does not employ a network object such as a base station but uses a direct communication link between communication devices. In other words, there are urgent needs for proposal, development, and improvement of communication technologies capable of supporting an environment where the users can obtain and share various kinds of information.

In particular, there is no specific method yet about how the initial link is to be set up between a device supporting the D2D service and a device supporting a service employing a link to a base station in a wireless communication system. Therefore, there is needed a method for establishing a link which utilizes limited radio resources in an efficient manner.

### SUMMARY OF THE INVENTION

The present invention provides a method and apparatus for establishing a link for a device-to-device (D2D) communication service in a wireless communication system. Also, the present invention provides a method and apparatus for providing a communication procedure for supporting a D2D communication service in a wireless communication system.

In an aspect, a method for supporting device-to-device (D2D) communication in a wireless communication system is provided. The method includes receiving a request message, which includes time information and resource information with respect to a signal of a corresponding user equipment (UE), for D2D communication from a network, estimating a channel state with respect to the signal of the corresponding UE by using the time information and the resource information, determining availability of D2D communication by taking account of the channel state, and transmitting a response message which includes indication information on the availability of D2D communication to the network.

In another aspect, a method for supporting device-to-device (D2D) communication in a wireless communication system is provided. The method includes receiving time information for signal transmission of a candidate user equipment (UE), information on uplink resources, and information on a reference signal from a network, receiving the reference signal transmitted from the candidate UE, estimating a channel state with respect to the received reference signal, transmitting information on the estimated channel state to the network, and receiving from the network a message which includes indication information on availability of D2D communication determined by taking account of the information on the channel state.

In another aspect, an apparatus for supporting device-to-device (D2D) communication in a wireless communication system is provided. The apparatus includes a radio frequency (RF) unit for transmitting or receiving a radio signal, and a processor, coupled to the RF unit, for determining allocated resource information. The processor is configured to receive a request message, which includes time information and resource information with respect to a signal of a corresponding user equipment (UE), for D2D communication from a network, estimate a channel state with respect to the signal of the corresponding UE by using the time information and the resource information, determine availability of D2D communication by taking account of the channel state, and transmit a response message which includes indication information on the availability of D2D communication to the network.

In providing a D2D communication service, a link may be established in a more explicit manner by taking into account cell interference and symbol interference with respect to each device. In particular, at the time of performing a procedure for D2D communication, an efficient D2D communication service may be provided by sharing information on channel state.

### BRIEF DESCRIPTION OF THE DRAWINGS

FIG. 1 shows a structure of a wireless communication system to which the present invention is applied.

FIG. 2 shows a concept of device-to-device (D2D) communication to which the present invention is applied.

FIG. 3 shows a signaling flow diagram for carrying out D2D communication according to the present invention.

FIG. 4 shows an example where the UE sets up/configures/obtains DL/UL timing to communicate with the eNB.

FIG. 5 shows a timing from a standpoint of UL transmission after the TA of FIG. 4 is applied.

FIG. 6 shows a D2D communication request procedure according to the present invention.

FIG. 7 shows a bilateral D2D communication request procedure.

FIG. 8 shows a signaling flow diagram of a UE to determine whether to convert to D2D communication according to the present invention.

FIG. 9 shows a signal flow diagram for establishing a D2D communication link according to the present invention.

FIG. 10 shows a block diagram of a structure of a wireless communication system according to the present invention.

### DESCRIPTION OF EXEMPLARY EMBODIMENTS

Hereinafter, this specification will describe a few embodiments according to the present invention in detail with reference to accompanying drawings. It should be noted that in assigning reference symbols to the respective constituting elements, the same symbols are used for the same constituting elements as possibly as can be throughout this specification though they may be found in different drawings. Also, for the sake of describing embodiments of the present invention, if it is determined that specific descriptions about a structure or a function known to the corresponding technical field unnecessarily obscures the technical principles of the present invention, the corresponding descriptions will be omitted.

This specification is related to a communication network. It is assumed that tasks of a communication network may be carried out by a system supervising the corresponding communication network (for example, a base station) while controlling the network and transmitting data, or the tasks may be carried out by a user equipment connected to the corresponding communication network. Also, techniques, devices, and systems described below may be applied to various wireless multiple access systems. Examples of a multiple access system include a code division multiple access (CDMA) system, frequency division multiple access (FDMA) system, orthogonal frequency division multiple access (OFDMA), single carrier frequency division multiple access (SC-FDMA) system, and multi carrier frequency division multiple access (MC-FDMA) system. CDMA may be implemented by a wireless technology such as universal terrestrial radio access (UTRA) or CDMA2000. TDMA may be implemented by a wireless technology such as global system for mobile communication (GSM), general packet radio service (GPRS), and enhanced data rates for GSM evolution (EDGE). OFDMA may be implemented by a wireless technology such as institute of electrical and electronics engineers (IEEE) 802.11 (Wi-Fi), IEEE 802.16 (WiMAX), IEEE 802-20, and evolved-UTRA (E-UTRA). UTRA is part of the universal mobile telecommunication system (UMTS), and 3^{rd} generation partnership project (3GPP) long term evolution (LTE) is part of the E-UMTS using the E-UTRA. The 3GPP LTE adopts OFDMA for downlink transmission and SC-FDMA for uplink transmission. The LTE-advanced (LTE-A) is the advanced from of the 3GPP LTE. For the convenience of description, it is assumed in the following that the present invention is applied to the 3GPP LTE or LTE-A. However, the present invention is not limited only to the aforementioned assumption. For example, even though details of the present invention are provided with respect to a mobile communication system based on the 3GPP LTE/LTE-A, the present invention may also be applied to any kind of mobile communication system except for the 3GPP LTE/LTE-A specific descriptions.

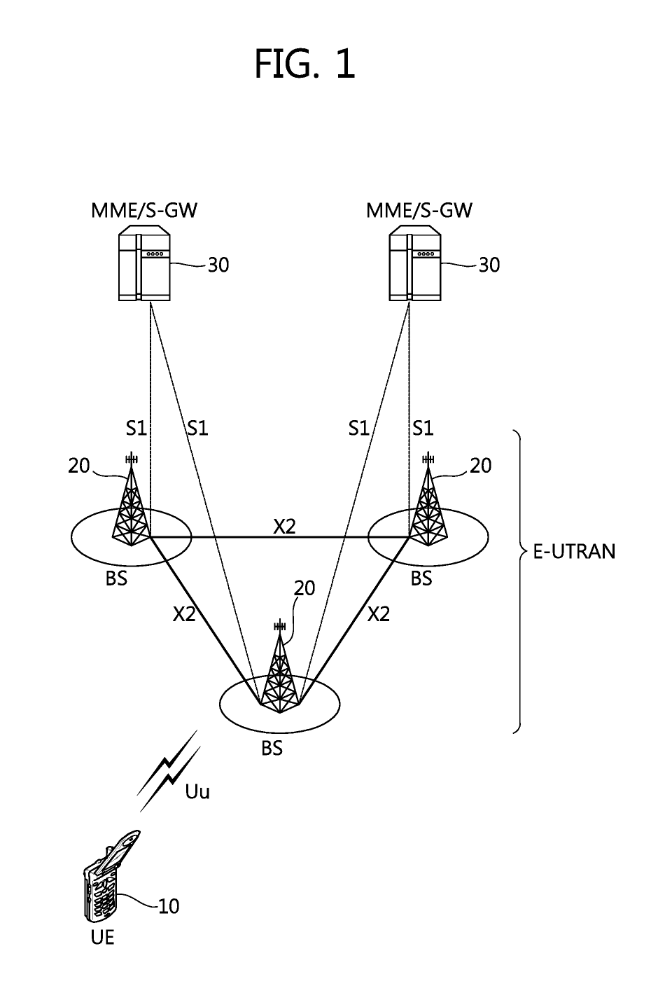

FIG. 1 shows a structure of a wireless communication system to which the present invention is applied. FIG. 1 discloses a network structure of evolved-universal mobile telecommunications system (E-UMTS). The E-UMTS may be called LTE or LTE-A system, which is a packet-based system for providing various communication services such as voice and packet data.

Referring to FIG. 1, E-UTRAN comprises an evolved-NodeB (eNB) 20 which provides a user equipment (UE) 10 with a control plane and a user plane. The UE 10 may be stationary or mobile, examples of which include various devices communicating with the eNB 20 and transmitting and receiving user data and/or various types of control information. The UE may also be called a terminal equipment (TE), mobile station (MS), mobile terminal (MT), user terminal (UT), subscriber station (SS), wireless device, personal digital assistant (PDA), wireless modem, and handheld device.

The eNB 20 may usually refer to a station performing communication with the UE 10 and may also be called a base station (BS), base transceiver system (BTS), access point, fembo-eNB, pico-eNB, home eNB, and relay. The eNB 20 may provide a service to the UE through at least one cell. A cell may denote a geographic region where the eNB 20 provides a communication service or a particular frequency band. Also the call may denote a downlink frequency resource and an uplink frequency resource. Furthermore, the cell may denote a combination of a downlink frequency resource and an optional uplink frequency resource. Also, it should be noted that the cell is a generic term indicating a local area covered by the eNB 20. The cell may be defined as various types of cells, including a mega cell, macro cell, micro cell, pico cell, femto cell according to the coverage size. The cell in this specification should be interpreted as a generic term representing coverage areas of various sizes.

Hereinafter, downlink denotes communication from the eNB 20 to the UE 10, and uplink denotes communication from the UE 10 to the eNB 20. In the downlink, a transmitter may be a part of the BS 20 while a receiver may be a part of the UE 10. In the uplink, a transmitter may be a part of the UE 10 while a receiver may be a part of the eNB 20.

For uplink and downlink transmission in which the present invention is applied, a time division duplex (TDD) scheme may be used, which carries out data transmission by using different time, or a frequency division duplex (FDD) scheme may be used, which carries out data transmission by using different frequencies.

The eNB 20 may be connected to each other through X2 interface. The eNB 20 may connected to an evolved packet core (EPC) 30 through S1 interface. More specifically, the eNB 20 may connected to a mobility management entity (MME) through S1-MME, and may connected to a serving gateway (S-GW) through S1-U. The S1 interface may exchange signals with the MME to communicate operation and management (OAM) information for supporting mobility of the UE 10.

The LTE system may group multiple, physically continuous or non-continuous frequency bands to provide the user with an effect of using a logically large frequency band, thereby providing a high transmission rate. The technique of using a logically large band by grouping a plurality of bands may be called carrier aggregation (CA). In other words, the CA is one of methods to satisfy service requirements of the users, where the method may employ multiple bands to support one service, support the service separately for each band, or use individual bands differently for data and control information.

As one example, it is assumed that the eNB 20 is capable of supporting N downlink component carriers (CCs) and the UE is capable of supporting a service through M downlink CCs based on the capability of the UE. In this case, frequency bandwidth corresponding to L downlink CCs may be set for a main CC. The UE, first of all, may monitor and receive the data transmitted through the main CC. In other words, CCs may be divided according to a cell type. If the CA is carried out by using CCs in a primacy cell (PCell) and CCs in a secondary cell (SCell), the CC in the PCell from among the carriers used in downlink and uplink transmission may be called a primary cell component carrier (PCC), while the CC in the SCell among the carriers used in downlink and uplink transmission may be called a secondary cell component carrier (SCC).

The UE may perform radio resource control (RRC) connection through the PCC of the PCell. Also, the UE may attempt a random access to the eNB through a physical random access channel (PRACH) based on a signal signaled through the PCC. In other words, the UE may perform a process of initial connection establishment or a process of connection re-establishment to the eNB through the PCC in a CA environment. Meanwhile, the SCC of the SCell may be used to provide additional radio resources. In order to perform CA which adds the SCC to the PCC, the UE needs to perform neighbor cell measurement, from which information on a neighbor cell is obtained. Based on the neighbor cell measurement carried out by the UE, the eNB may determine whether to aggregate the SCC into the PCC. The PCell is always activated while the SCell operates according to an activation/deactivation command of the eNB, where the activation/deactivation may be commanded in the form of a media access control (MAC) message. Also, in the PCell, a legacy subframe may be transmitted through the PCC. On the other hand, in the SCell, not only the legacy subframe may be used but also a new form of subframe, which effectively reduces and transmits a control channel and reference signals transmitted from the legacy subframe, may be transmitted through the SCC. In other words, in a new LTE-A release, a new format of subframe may be defined and used. Hereinafter, for the convenience of description, a new form of subframe different from an existing subframe may be defined as a new subframe or extension subframe.

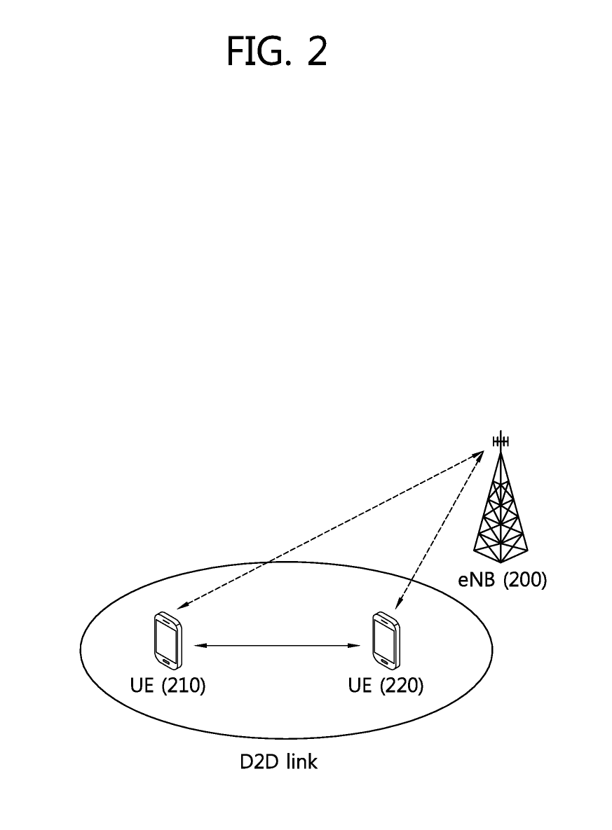

FIG. 2 shows a concept of device-to-device (D2D) communication to which the present invention is applied.

Referring to FIG. 2, D2D communication performs transmission and reception between devices without incorporating relaying of an eNB. UEs in an existing communication system may always perform communication to and from the eNB. Different from the above, a D2D communication system according to the present invention, if direct communication between UEs is possible, for example, UEs are located geographically close to each other or a channel condition between the UEs is good, actual control of the UEs may still performed by the eNB (dotted line), but actual data information (or information related to the data (for example, hybrid automatic repeat request (HARQ)) or information about network management/control between UEs) may be communicated by direct communication between UEs (solid line). In other words, to establish a direct link between two or more UEs, the eNB may command D2D communication between two UEs, allocate a predetermined amount of resources for D2D communication between UEs, inform the two UEs about the allocation of a predetermined amount of resources (alternatively, a primary UE is determined to communicate related information with the UE and communication between the UEs may be carried out through the primary UE), and the UEs directly may send and receive actual data without incorporating the eNB under the command of the eNB. At this time, the whole communication between the UEs may be carried out by the D2D communication, but it is preferable that actual data and the least control related to the data are transmitted and received between the UEs while a required control is transmitted and received continuously to and from the eNB. Hereinafter, it is assumed that performing the D2D communication according to the present invention does not exclude connection to and communication with the eNB.

In other words, overall parameters related to physical/MAC layer, including direct communication request/response information, resource allocation information as scheduling information, security information, and information required to perform D2D communication between UEs (information about which method to use from among various D2D communication candidates and parameters characterizing D2D communication (maximum power, coverage, data rate, modulation and coding scheme (MCS), multiple-input multiple-output (MIMO) scheme/mode, antenna configuration, frame structure, subframe composition)), may be communicated between UE(s) performing D2D communication with the eNB before D2D communication between UEs is carried out. Depending on the needs, particular control information may be communicated between the eNB and the UE(s) in the middle of D2D communication between the UEs. The description above assumes a D2D configuration, but a node playing the role of a relay may be included in the configuration, forming a part of a local network comprising nodes representing an ad hoc network.

The D2D communication according to the present invention may perform communication directly between UEs, thereby not only reducing load of the eNB but also reducing transmission power and increasing reusability of frequency bands. In other words, the D2D communication may make an efficient use of limited resources. Also, in terms of transmission power, the D2D communication may be more efficient from the standpoint of UE since communication may be carried out with lower power when the distance between UEs is small compared with a case of sending traffic to an eNB located at a distant place. In other words, since communication may be carried out with low power, multiple D2D links may accommodate communication at the same time within the same cell, frequency reusability may be increased.

Meanwhile, the D2D communication according the present invention, taking account of D2D transmission based on the LTE protocol, may allocate and schedule resources with respect to the eNB. In other words, the eNB may hold a control right for resource allocation of each D2D connection. At this time, information on scheduled resources may be provided to UEs through L1/L2 signaling through a physical downlink control channel (PDCCH). In other words, UEs (UE1, UE2) 210, 220 may directly communicate data by using allocated resources under the command of the eNB 200. At this time, although the whole communication may be carried out through the D2D communication between the UEs, the UEs may be responsible only for transmission of actual data and communication of minimal control information related to the data. Control information of the eNB 200 and communication of data may be supported when needed.

Meanwhile, N_{RB}, which is the number of resource blocks included in a downlink slot of the present invention, may be determined according to the downlink transmission bandwidth determined in a cell. For example, in the LTE system, N_{RB} may assume any value from 6 to 110 according to the transmission bandwidth employed. One resource block may include a plurality of subcarriers in the frequency domain. Here, each element on a resource grid may be called a resource element (RE). Each RE may be identified by an index pair (k, 1). Here, k (k=0, . . . , N_{RB}×12−1) is an index of a subcarrier in the frequency domain and 1 (1=0, . . . , 6) is an index of OFDM symbol in the time domain. In other words, one resource block may comprise 7×12 resource elements consisting of 7 OFDM symbols in the time domain and 12 subcarriers in the frequency domain.

Also, the number of OFDM symbols included in one slot may be varied according to a cyclic prefix (CP) as described above. Furthermore, the number of resource blocks included in one slot may be varied according to the size of the whole frequency bandwidth.

As described above, as D2D transmission based on the LTE protocol is taken into account, a D2D link may either support a communication method using temporal synchronization between the UE and the eNB or a communication method of setting the D2D link without synchronizing with the eNB.

If the UE performs communication by using temporal synchronization with the eNB, propagation delay between UEs belonging to the D2D link and inter-symbol interference (ISI) due to existence of propagation delay between the UE and the eNB may occur. Taking account of the problem, the present invention provides a frame structure considering the inter-symbol interference or a synchronization setting procedure. First of all, a basic resource allocation procedure with the eNB will be described below.

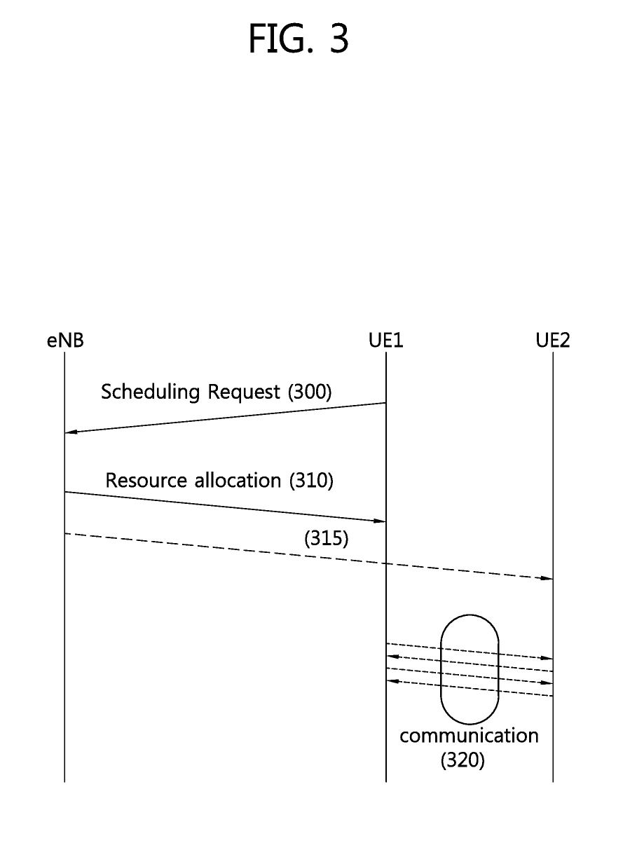

FIG. 3 shows a signaling flow diagram for carrying out D2D communication according to the present invention.

Referring to FIG. 3, UE1 requests the eNB for communication with UE2 (300). The request may be requested by the eNB to the UE1 or requested directly to another UE. Also, the request may include a scheme of communicating data between UEs without employing contention-based request.

The eNB may perform resource allocation (or bandwidth/grant) for downlink and/or uplink for D2D communication on the UE1 and UE2 (310, 315). Here, in the step of 310, 315, a procedure in which the eNB inquires the UE2 about D2D communication and respond to the UE1 with the inquiry result may be included. Also, in the step of 300, UE2 may also request the eNB for communication with the UE1, skipping the step of inquiring the UE2 about D2D communication and responding to the UE2 as described above.

Signaling with respect to D2D communication may include indication about D2D communication, etc. In other words, whether the D2D communication is available or not may be indicated in the form of ON/OFF signaling. Here, the indication about the D2D communication may include information on a particular UE requested by the UE1 or may further include information on candidate UE(s) capable of communicating with the UE1, and optionally, an ON/OFF indicator representing capability of D2D communication with the corresponding UE.

Meanwhile, resource allocation for the UE1 and the UE2 may be signaled independently for each UE or may be dealt with through common signaling. Also, the resource allocation may include resources of frequency, time, or a combination of frequency and time for D2D communication with respect to the UE1 and the UE2.

Therefore, UE1 and UE2 may perform communication directly through allocated resources (320). At this time, the D2D UEs may perform data transmission and reception irrespective of control (intervention) of the eNB. In other words, while minimizing unnecessary communication performed by the eNB, the UE1 and the UE2 may perform communication directly with each other. As described above, communication time/order and UL/DL time/order of UE 1 and UE2 with respect to the eNB, and communication time/order and UL/DL time/order between UEs have been simplified for the purpose of convenience, the order of which may be changed or omitted according to scheduling of the eNB, condition of each UE, and the amount of transmission of each UE. Also, signals such as additional control information and measurement may be communicated between the UE and the eNB and between the UEs.

Hereinafter, the present invention provides a method for preventing or minimizing interference which may occur at the time of transmission and reception related to transmission and reception timing or acquisition of synchronization between UEs through D2D communication. In particular, as one example, the present invention may be applied implicitly to a random access procedure for D2D communication at the time of the initial transmission based on the D2D communication or may always be applied at the time of D2D communication. Hereinafter, timing refers to transmission timing for transmitting a transmission signal, timing for determining a subframe boundary of the transmission signal, reception timing for detecting a reception signal, or timing for determining a subframe boundary of the reception signal. Hereinafter, it is assumed that UL and DL transmission employs the FDD scheme. However, the assumption is made only for the sake of convenience and may be extended to include the TDD scheme. It is further assumed that the DL subframe boundary and the UL subframe boundary of the eNB are aligned in terms of absolute time. However, the assumption is also made for the sake of convenience and may be extended to a case where subframe boundaries are different from each other.

In most cases, a UE performing communication with the eNB may obtain the DL reception timing by using the DL synchronization signal of the eNB. Afterwards, the UE may set up the initial transmission timing for UL transmission from the obtained DL subframe boundary (for example, with the same or a predetermined offset) and obtains the UL transmission timing through the PRACH procedure.

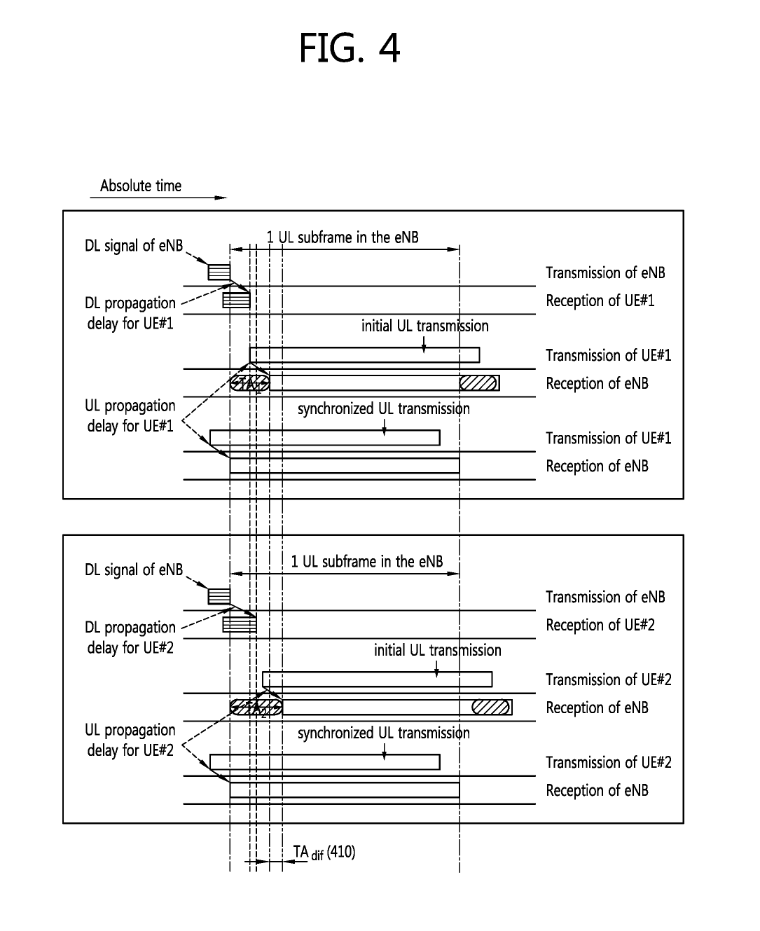

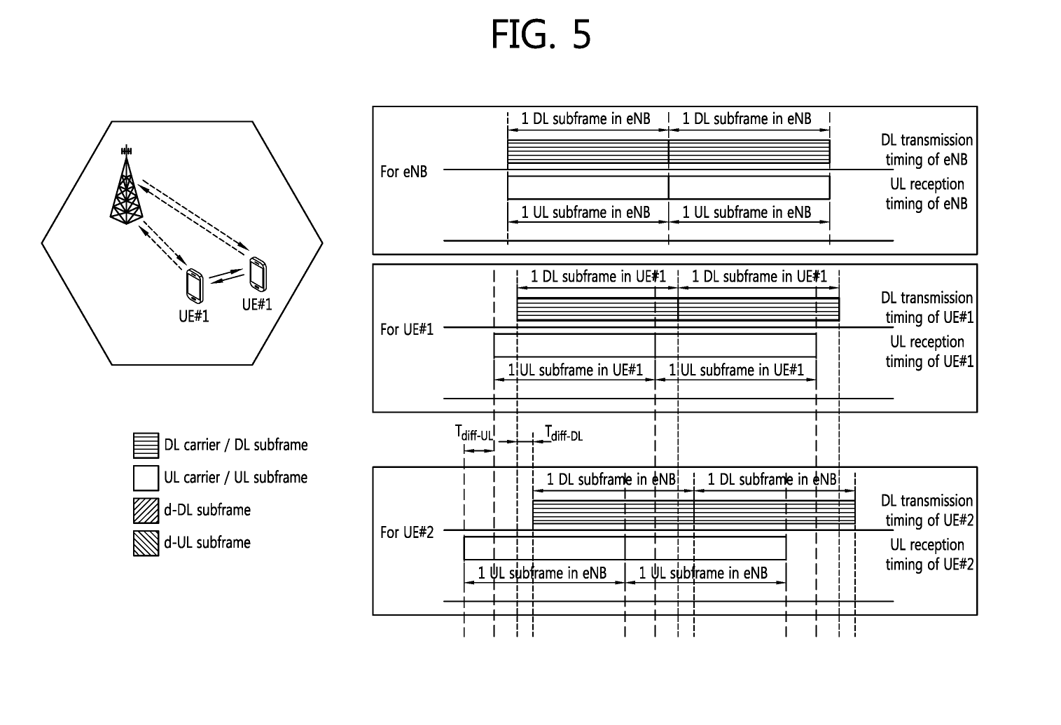

FIGS. 4 and 5 a procedure for obtaining synchronization to which the present invention is applied.

FIG. 4 shows an example where the UE sets up/configures/obtains DL/UL timing to communicate with the eNB. The eNB transmits a DL signal. UE1 receives the DL signal with a propagation delay in proportion to a relative distance from the eNB. In other words, the UE1 may obtain the DL reception timing with the propagation delay by using the DL synchronization signal. Afterwards, the UE, which is not set up with the initial uplink transmission timing, performs the initial random access procedure to obtain the UL timing. Assuming that the PRACH uses UL transmission timing (UL subframe or frame boundary) which is the same as the DL reception timing (namely, DL subframe or frame boundary), the UE performs PRACH transmission. Here, a predetermined offset of the DL reception timing and the UL transmission timing may be used. In other words, a system may be operated so that the UL subframe boundary may be set up to be displaced from the obtained DL subframe by a predetermined time period. After the UE transmits the PRACH with the UL transmission timing, the eNB receives the signal after a propagation delay in proportion to the distance between the UE and the eNB.

Therefore, seen from the eNB as a receiver, the PRACH may be received with a propagation delay as large as a summation of the DL propagation delay and the UL propagation delay. At this time, the eNB estimates the total delay through PRACH detection and informs the UE about how much the UE has to transmit the UL transmission timing in advance. This is called a timing advance (TA). Hereinafter, the TA acquisition process described above may be applied the same to the UE2. In this case, it is assumed that UE2 is located at a more distant place from the eNB than the UE1, and thus DL and UL propagation delay exerts a larger influence. Also, a difference between UL transmission timings of the UEs is denoted as TA_{diff} (430).

Meanwhile, FIG. 5 shows a timing from a standpoint of UL transmission after the TA of FIG. 4 is applied. It is assumed that subframe boundary for DL and UL transmission is aligned in the eNB. Since the UE2 is located at a relatively more distant place from the eNB compared with the UE1, and therefore, a larger DL and UL propagation delay is made. Therefore, the DL reception timing of UE2 lags behind that of the UE1, and thus, the UL transmission timing is formed earlier. To this purpose, a TA update procedure may be applied.

Meanwhile, to convert the UEs connected to the eNB into D2D communication, a channel state between a pair of transmitter and receiver which form a D2D link needs to be checked. Since the eNB is unable to know the channel state between the transmitter-receiver pair, the eNB may select an arbitrary pair of transmitter and receiver as a D2D communication candidate and requests transmission of a signal for checking the D2D link channel state. Afterwards, if the D2D link channel is checked, whether to convert to D2D communication may be determined based on the checked result. If it is determined that conversion to D2D communication is not possible, energy and communication resources used for transmitting a signal to check the D2D link channel may be wasted. Therefore, it is necessary for the eNB to check approximately availability of D2D communication before the UEs transmit an additional signal to check the channel between the UEs or check the channel state of the D2D link without a signal transmitted by the UEs.

To this end, the present invention provides a method for establishing a D2D link while the transmitter of a UE does not transmit a separate discovery signal when the eNB requests direct communication. At this time, the present invention assumes that the UE A is a transmitter and the UE B is a receiver, and the UE A is connected to its eNB through an uplink while the UE B is connected to its eNB through a downlink. At this time, the entity which requests D2D communication is the eNB.

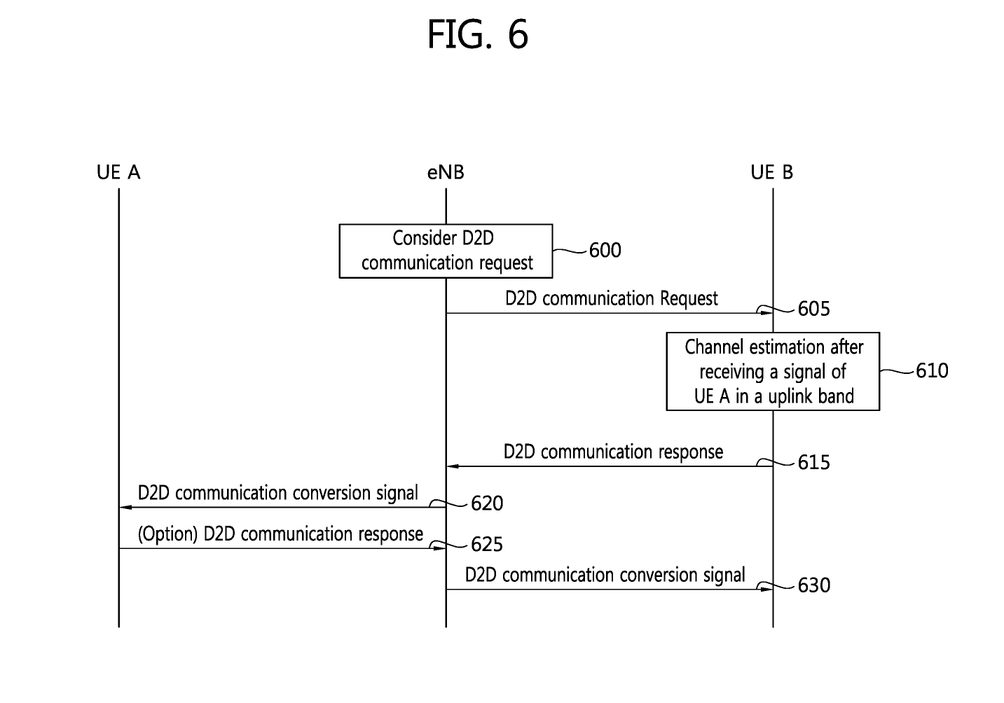

FIG. 6 shows a D2D communication request procedure according to the present invention.

Referring to FIG. 6, if the eNB determines to request D2D communication (600), the eNB transmits a D2D communication request signal to the UE B (605). At this time, the UE A may continuously transmit a signal through the uplink while the UE B may continuously receive the signal through the downlink. In other words, while performing the D2D communication request procedure, the UE B may continuously receive the signal of the UE A through the eNB.

The UE B receives a signal of the UE A in the uplink band by using information included in the D2D communication request signal. Based on the reception signal, the channel state between the UE A and the UE B is checked (610). Afterwards, the UE B transmits a D2D communication response signal which includes channel state information between the UE A and the UE B to the eNB (615).

The eNB may determine conversion to D2D communication based on the channel state information included in the D2D communication response signal obtained from the UE B. After the determination, if conversion to D2D communication is confirmed, the eNB transmits a D2D communication conversion signal to the UE A (620). At this time, the UE A may transmit a response signal with respect to the D2D communication conversion signal to the eNB, which may be operated optionally (625).

Also, the eNB may transmit a D2D communication conversion signal to the UE B to command the conversion to D2D communication (630). At this time, only when the eNB receives a response signal with respect to the D2D communication conversion from the UE A, the eNB may transmit the D2D communication conversion signal to the UE B.

After the D2D communication request procedure is completed, a procedure for establishing a unilateral or bilateral D2D communication connection between the UE A and the UE B may be defined separately. For example, in the autonomous D2D communication where the eNB does not allocate D2D communication resources, whether to convert to D2D communication is confirmed through a communication request procedure, after which a procedure for the UEs to allocate resources autonomously without support of the eNB may be carried out. On the contrary, if the eNB is involved in resource allocation of D2D communication, resources to be used for D2D communication may be allocated simultaneously in the D2D communication request procedure.

At this time, information contained in each signal of the D2D communication request procedure may have various forms as follows according to a D2D transmission and reception technique and a D2D determination technique. As a first embodiment, if whether to convert to D2D communication is determined by the UE, signals at the respective steps may have information different adaptively from each other, which is described below.

The D2D communication request signal 605 may include information representing signal transmission time of UE A, information on uplink resources through which the signal from the UE A is transmitted, and reference signal information of the UE A. The D2D communication request signal may further include information on D2D communication permissible maximum propagation delay, a threshold for determining whether to convert into D2D communication, or coding information and information on a modulation scheme of UE A uplink transmission.

A D2D communication link may be established as follows. The UE A delivers an OFDM signal with an added CP to the eNB through uplink. Therefore, upon receiving the D2D communication request signal from the eNB, the UE B may determine the signal transmission time of the UE A included in the D2D communication request signal as the start point of the OFDM symbol, and perform Fourier transform (FT) on the reference signal received from the UE A. If a signal propagation delay between the UE A and B is smaller than the CP, the UE B may obtain the symbol of the UE A in a phase shifted form. The amount of phase shift may be known from the reference signal, and the propagation delay between the UE A and the UE B may be obtained by inverse calculation of the phase shift. Meanwhile, if the signal propagation delay between the UE A and B is larger than the CP, phase shift of the symbol may not appear to be uniform due to inter-cell interference (ICI) and/or Inter-symbol interference (ISI). Therefore, in case the phase shift is not uniform, it may be determined that time synchronization error is larger than the CP. In other case, the propagation delay between the UE A and B may be predicted by estimating time synchronization with a predetermined algorithm (e.g., Van de Beek) based on the CP of OFDM signal without incorporating fast Fourier transform (FFT).

Therefore, in case the propagation delay of the UE A is smaller than the predetermined CP, the UE B may determine that conversion to D2D communication is available. At this time, large propagation delay between the UE A and B indicates that distance between the UE A and B is large. On the other hand, since conventional D2D communication is performed within a short range, the corresponding UEs may be excluded from the D2D communication candidates when the propagation delay is large.

Also, in case the D2D communication permissible maximum propagation delay is received from the eNB, the predicted propagation delay is smaller than the predetermined threshold, it may be determined that conversion to D2D communication is available. At this time, the D2D communication permissible maximum propagation delay may be smaller or larger than the CP.

Meanwhile, channel state between the UE A and the UE B may be estimated by using the reference signal, and afterwards, if the estimated channel state exceeds a predetermined threshold, it may be determined that D2D communication is available. For example, if signal-to-noise ratio (SNR) of a received signal of the UE B exceeds a particular threshold, it may be determined that D2D communication is available. Also, the present invention may use both of a method for comparing the predicted propagation delay with the maximum propagation delay and a method for comparing a channel estimated result with a predetermined threshold for channel estimation. If the two conditions are all met, it may be determined that D2D communication is available.

Also, phase shift due to the propagation delay between the UE A and B may be compensated by using the reference signal, after which the compensated phase shift may be stored in a buffer. Accordingly, a signal of the UE A is received from the eNB through downlink, and the received signal is decoded, after which the decoded signal is recovered by using a modulation scheme and an encoding scheme by which the UE A has transmitted the signal through uplink. And by using the recovered uplink signal of the UE A as a reference signal, the channel state between the UE A and B may be estimated. If the estimated channel state exceeds a threshold, it may be determined that D2D communication is available. Also, by using all of the information on the propagation delay, information on compensation of the reference signal, and information on the threshold, it may be determined that D2D communication is available when all of the conditions are met.

The D2D communication response signal 615 of the UE B may include information indicating availability of conversion to D2D communication. As described above, upon receiving the D2D communication response signal of the UE B, the eNB transmits a D2D communication conversion signal to the UE A. If no response is received from the UE A within a predetermined time period, the eNB may transmit again the D2D communication request signal or may determine with respect to the UE A that D2D communication is unavailable.

More specifically, after transmitting the D2D communication conversion signal to the UE A, if the eNB fails to receive a D2D communication response from the UE A, the eNB may transmit again the D2D communication conversion signal or may determine that D2D communication is unavailable. At this time, if resources for D2D communication and resources for device-to-BS (D2B) communication are separated, the eNB may inform the UE A about the resources to be used for D2D communication.

At this time, the D2D communication conversion signal 620 for the UE A may include information indicating conversion to D2D communication. In other words, the D2D communication conversion signal may include information on resources to be used for the UE A to transmit a signal directly to the UE B, information representing a signal transmission time of the UE B, or D2D communication link identification information. In other words, the D2D communication conversion signal may include information for notifying about signal transmission time of the UE B. The corresponding information may be used for establishing a bilateral D2D link. This is so because, if a propagation delay is smaller than a predetermined CP when the UE B receives a signal of the UE A, the propagation delay is smaller than CP even when the UE A receives a signal at the time of transmission of a signal by the UE B. Also, the D2D communication conversion signal may inform of the ID of the D2D link when one ID is assigned to the D2D link. In other case, the D2D communication conversion signal may inform of ID of the UE B.

The D2D communication response signal corresponding to the above may include information indicating successful reception of the D2D communication conversion signal (acknowledgement/non-acknowledgement (ACK/NACK)). If the UE A transmits the D2D communication response signal and the eNB receives the signal, the eNB transmits the D2D communication conversion signal to the UE B. If the eNB fails to receive the signal, the eNB may transmit the D2D communication conversion signal to the UE A or may determine that D2D communication is unavailable.

After transmitting the D2D communication response signal to the UE B, the UE A and UE B convert into a D2D communication mode. In addition, the D2D communication conversion signal for the UE B may include information indicating D2D communication conversion, information on resources to be used for the UE A to transmit a signal directly to the UE B, and D2D communication link identification information. In other words, if resources for D2D communication and resources for D2B communication are separated, the eNB may inform the UE B about the resources to be used for D2D communication. The eNB may inform of the ID of the D2D link when one ID is assigned to the D2D link. In other case, the eNB may inform of ID of the UE A.

As a second embodiment, a case where the eNB determines whether to convert to D2D communication will be described. In this case, the D2D communication request signal may include information representing signal transmission time of UE A, reference signal information of the UE A, information on uplink resources through which the signal from the UE A is transmitted, etc. As one example, the D2D communication request signal may further include information on D2D communication permissible maximum propagation delay, coding information and information on a modulation scheme of UE A uplink.

Also, the D2D communication response signal of the UE B may include reception channel information of the UE B and information indicating whether to convert to D2D communication.

The D2D communication conversion signal for the UE A by the eNB may include information indicating conversion to D2D communication. Further, the D2D communication conversion signal may include information on resources to be used for the UE A to transmit a signal directly to the UE B, channel information between the UE A and B, information representing a signal transmission time of the UE B, and D2D communication link identification information. The D2D communication response signal of the UE A may include ACK/NACK information indicating successful reception of the D2D communication conversion signal.

Also, the D2D communication conversion signal for the UE B by the eNB may include information indicating conversion to D2D communication, information on resources to be used for the UE A to transmit a signal directly to the UE B, or D2D communication link identification information.

A D2D communication link may be established as follows in the second embodiment using individual signals including the above information.

The UE A delivers an OFDM signal with an added CP to the eNB through uplink. Therefore, the basic operation after receiving the D2D communication request signal may be the same as described in the first embodiment. However, the UE B does not determine whether to convert to D2D communication, but channel information between the UE A and UE B estimated by the UE B may be quantized and transmitted to the eNB. At this time, if the D2D communication permissible maximum propagation delay is received from the eNB, if the estimated propagation delay is smaller than the predetermined propagation delay, it may be determined that conversion to D2D communication is available. Here, the D2D communication permissible maximum propagation delay may be smaller or larger than the CP. Also, using a channel estimation method and taking into account both of the maximum propagation delay and the threshold for channel estimation as described in the first embodiment, if the two conditions are met, it may be determined that D2D communication is available. At this time, the process for each UE to quantize the channel state and transmit the quantized channel state to the eNB, and for the eNB to determine whether to convert to D2D communication according to the second embodiment may employ various methods of the first embodiment in the same way for determining conversion to D2D communication by the UE of the first embodiment, which is different from the second embodiment in that the determining subject is different, and applying each conversion condition. The methods of the first embodiment may also be applied after part of them is modified according to the determination of a network.

Therefore, after the UE B receives the D2D communication response signal, the eNB may finalize whether to convert to D2D communication by using channel information between the UE A and B. At this time, after transmitting the D2D communication conversion signal to the UE A, the basic operation may include the same as in the first embodiment. At this time, if resources for D2D communication and resources for D2B communication are separated, the eNB may inform the UE A about the resources to be used for D2D communication. Also, as the eNB transmits channel information between the UE A and B to the UE A, the UE A may determine a modulation scheme and a coding method by using the corresponding information at the time of D2D communication.

The eNB may include information indicating signal transmission time of the UE B in the D2D communication conversion signal. In particular, the corresponding signal may be used to set up a bilateral D2D link. Also, under an assumption that the channel between the UE A and B is symmetric, the UE B may determine the modulation scheme and coding method by using the estimated channel when the UE B transmits a signal to the UE A. Also, the D2D communication conversion signal may inform of the ID of the D2D link when one ID is assigned to the D2D link. In other case, the D2D communication conversion signal may inform of ID of the UE B.

If the UE A transmits the D2D communication response signal and the eNB receives the response signal, the eNB may transmit the D2D communication conversion signal to the UE B. If the eNB fails to receive the conversion signal, the eNB may transmit the D2D communication conversion signal again to the UE A or may determine that D2D communication is unavailable.

Also, after the eNB transmits the D2D communication response signal to the UE B, the UE A and B convert to the D2D communication mode. At this time, if resources for D2D communication and resources for D2B communication are separated, the eNB may inform the UE B about the resources to be used for D2D communication. Also, the eNB may inform of the ID of the D2D link when one ID is assigned to the D2D link. In other case, the eNB may inform of ID of the UE A.

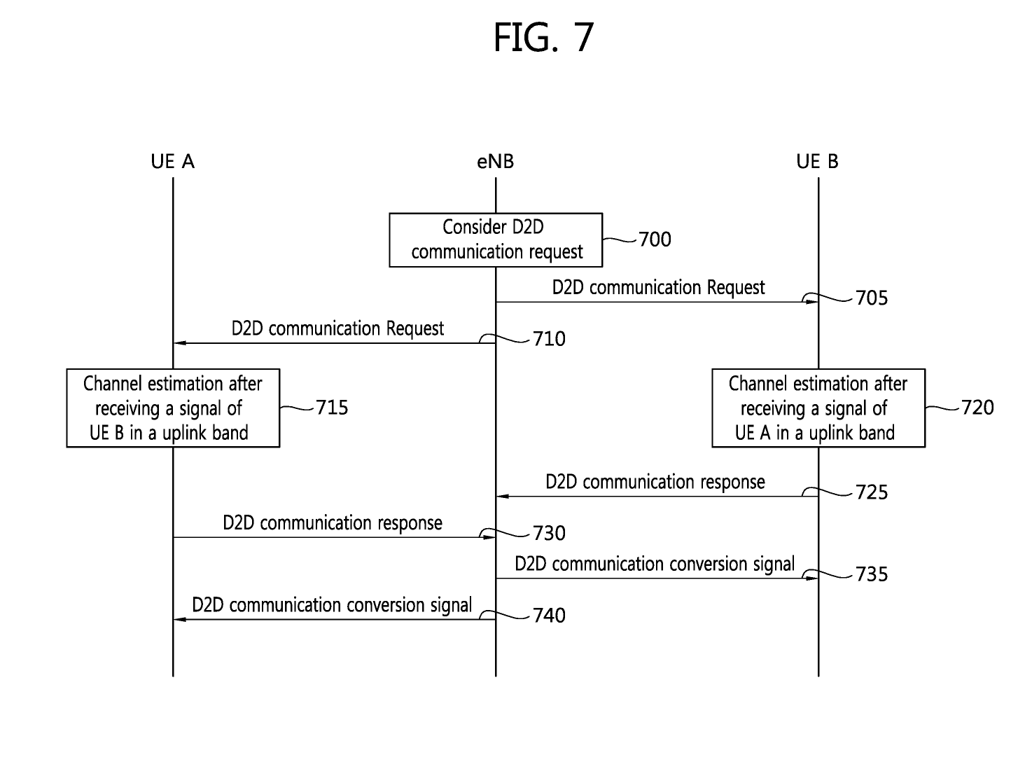

As described above, the D2D communication request procedure may also be used for establishing a bilateral D2D communication link under the assumption that the channel of the UE A-B link and that of the UE B-A link are symmetric. For more accurate bilateral D2D communication establishment, FIG. 7 shows a bilateral D2D communication request procedure.

Referring to FIG. 7, if the eNB determines to request D2D communication (700), the eNB transmits a D2D communication request signal to the UE A and B (711, 712). At this time, the UE A may transmit a signal continuously through uplink, and the UE B may receive a signal continuously through downlink. In other words, while performing the D2D communication request procedure, the UE B may continuously receive the signal of the UE A through the eNB. Also, the UE B may transmit a signal continuously through uplink, and the UE A may receive a signal continuously through downlink. In other words, while performing the D2D communication request procedure, the UE A may continuously receive the signal of the UE B through the eNB. At this time, the D2D communication request signal for the UE B may include information representing signal transmission time of UE A, reference signal information of the UE A, information on uplink resources through which the signal from the UE A is transmitted, information on D2D communication permissible maximum propagation delay, coding information and information on a modulation scheme of UE A uplink. Also, the D2D communication request signal for the UE A may include information representing signal transmission time of UE B, reference signal information of the UE B, information on uplink resources through which the signal from the UE B is transmitted, information on D2D communication permissible maximum propagation delay, coding information and information on a modulation scheme of UE B uplink.

Accordingly, the UE B receives a signal of the UE A in the uplink frequency band by using the information included in the D2D communication request signal. Based on the received signal, the channel state of the UE A-B link is checked (722). Likewise, the UE A receives a signal of the UE B in the uplink frequency band by using the information included in the D2D communication request signal. Based on the received signal, the channel state of the UE B-A link is checked (721).

The UE B transmits the D2D communication response signal including channel state information of the UE A-B link to the eNB (732). The UE A transmits the D2D communication response signal including channel state information of the UE B-A link to the eNB (731). The D2D communication response signal of the UE B may include reception channel information of the UE B and information indicating whether to convert to D2D communication. The D2D communication response signal of the UE A may also include reception channel information of the UE A and information indicating whether to convert to D2D communication.

If the eNB confirms conversion to D2D communication based on the information transmitted by the UE B, the eNB may transmit the D2D communication conversion signal to the UE A and B (741, 742). At this time, the D2D communication conversion signal for the UE B may include information indicating conversion to D2D communication, reception channel information of the UE A, information on resources to be used when the UE A transmits a signal directly to the UE B, information on resources to be used when the UE B transmits a signal directly to the UE A, and D2D link identification information such as D2D link ID. Similarly, the D2D communication conversion signal for the UE A may include information indicating conversion to D2D communication, reception channel information of the UE B, information on resources to be used when the UE A transmits a signal directly to the UE B, information on resources to be used when the UE B transmits a signal directly to the UE A, and D2D link identification information such as D2D link ID.

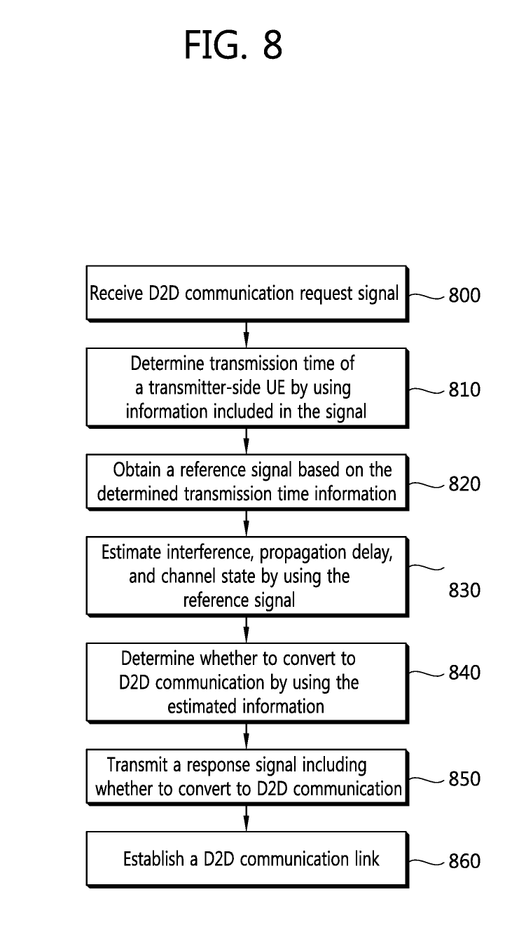

FIG. 8 shows a signaling flow diagram of a UE to determine whether to convert to D2D communication according to the present invention.

Referring to FIG. 8, the UE A receives a D2D communication request signal including signal transmission time of the UE B to perform D2D communication by forming a pair with the UE A, uplink resource information, and information on a reference signal (800). The D2D communication request signal may include a predetermined threshold (which includes information on maximum propagation delay) with respect to a time period required to determine whether to convert to D2D communication, information on compensation for signal reconstruction, and information on a demodulation scheme. The UE A determines transmission time of the UE B by using information included in the D2D communication request signal (810). The UE B, which obtains a reference signal of the UE A based on the determined transmission time information, estimates signal interference on the UE B and channel state by using the obtained reference signal (820). Also, propagation delay may be predicted through the time at which the reference signal is obtained. By comparing the predicted propagation delay with the time information for determining the conversion to D2D communication, namely, by using the estimated and predicted information, the UE A determines whether to convert to D2D communication (840).

As one example, if the acquisition time of the reference signal exceeds a predetermined threshold for D2D communication conversion or the propagation delay exceeds a predetermined CP, it may be regarded as inter-symbol interference or symbol phase shift, and therefore, it may be determined that conversion to D2D communication is not available. Also, if the channel state of the UE B exceeds a predetermined threshold, it may be determined that the channel state is not appropriate for D2D communication.

Also, if it is determined from uplink coding information and a modulation scheme with respect to the UE B that the checked symbol and phase shift of the checked reference signal are not uniform, it may be determined that conversion to D2D communication is not available. In other words, by taking into account the channel state, distance, and channel path between UEs according to the present invention, namely, by using information for conversion to D2D communication, time synchronization and channel synchronization may be predicted and determined, based on which a D2D link with good link quality may be established and searched so that inter-symbol interference and interference on neighbor cells can be avoided. In other words, suitability of a link may be evaluated by taking account of time synchronization based on the maximum propagation delay and the signal acquisition time.

The UE A transmits a response signal including information on conversion to D2D communication to a network and the UE B which forms a pair with the UE A (850). Therefore, the UE A receives the D2D conversion signal indicating proper operation of conversion to D2D communication from the network or the UE B (860). The D2D conversion signal may include channel information of a UE which performs D2D communication, information on transmission time, and identification information on a D2D communication link. Therefore, the UE A may establish a D2D communication link which ensures more accurate performance. Therefore, the present invention may support efficiency of D2D communication by establishing a link which ensures a good channel state and time synchronization.

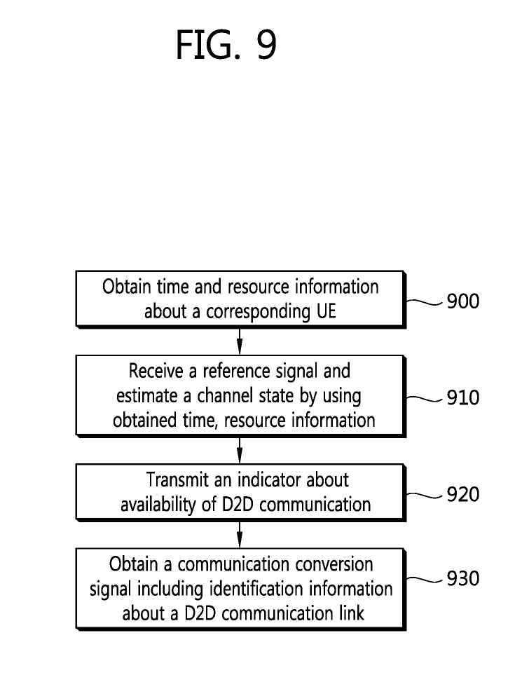

FIG. 9 shows a signal flow diagram for establishing a D2D communication link according to the present invention.

Referring to FIG. 9, a UE A receives a communication request message including time information and resource information with respect to a corresponding UE to perform D2D communication from a network (900). The request message may include signal transmission time with respect to the corresponding UE, information on a reference signal, information on uplink resources, coding/modulation information, and information on maximum propagation delay. Link suitability may be evaluated by taking account of time synchronization with the UE A by using the maximum propagation delay and signal transmission time. The UE A receives a reference signal of the corresponding UE by using information included the communication request message and may estimate a channel state for establishing a link by using the received reference signal (910). Therefore, the UE A defines an indicator indicating availability of D2D communication, and informs the network about the availability of D2D communication (920).

Afterwards, the UE A receives from a network a communication conversion signal which informs that a link may be established between UEs for D2D communication and includes information on the link (930). The communication conversion signal may further include resource information on a corresponding UE, channel state information, and information on transmission time. Therefore, the present invention may support efficiency of D2D communication by establishing a link which ensures a good channel state and time synchronization.

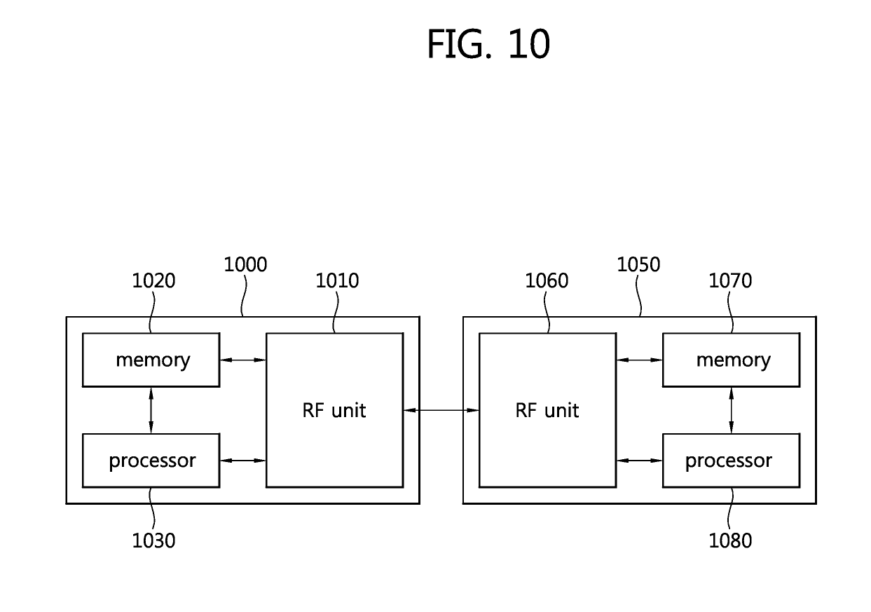

FIG. 10 shows a block diagram of a structure of a wireless communication system according to the present invention.

Referring to FIG. 10, the UE 1000 comprises a radio frequency (RF) unit 1010, a memory 1020, and a processor 1030. The RF unit 1010, being connected to the processor 1030, transmits and receives a radio signal.

The processor 1030 is an entity performing a function, procedure, and method according to the present invention. The processor 1030 performs operation of FIGS. 2 to 9 of the present invention. In particular, the processor 1030 according to the present invention may receive configuration information and resource allocation information indicated by a network which is an upper system, and may support simultaneous connection or partial connection of D2D communication and cellular communication according to the capability of the UE. At this time, the processor 1030 may perform communication with a different D2D UE by detecting a link performing D2D communication without signaling of the eNB.

In particular, the processor 1030 according to the present invention checks allocated time information and resource information for performing D2D communication.

Resources and parameters for the D2D communication may include time information, information on uplink resources, and information on a reference signal to minimize interference with symbols performing cellular communication or inter-symbol interference due to the UE for which a different D2D link is applied. Also, to establish a link by taking account of propagation delay with respect to a signal transmitted from a corresponding UE and a channel state, the present invention may include time information on maximum permissible propagation delay and a threshold with which to determine whether to convert to D2D communication. The information may be defined adaptively by taking account of inter-symbol interference and interference between neighbor cells, and may be defined by considering a guard symbol.

To describe again, the processor 1030 may obtain information on a reference signal by using the time information and resource information, namely, information representing signal transmission time transmitted from the corresponding UE and information on uplink resources through which the corresponding signal is transmitted. And, the processor 1030 may determine whether to convert to D2D communication from evaluation of validity of the reference signal by using the information on D2D communication permissible maximum propagation delay and a threshold with which to determine whether to convert to D2D communication. On the other hand, the processor 1030 may estimate a channel state by using the information above and transmit the estimated channel state to the network. And, the processor 1030 may perform conversion to D2D communication by receiving a signal including a signal for conversion to D2D communication and a signal including identification information on a D2D link. Also, the processor 1030 may decode the received reference signal by using the received information about coding/modulation scheme with respect to the corresponding UE, thereby determining phase shift. In other words, to establish a more accurate D2D communication link, the information may be used to establish a link which prevents inter-symbol interference and interference between neighbor cells beforehand by taking account of phase shift due to propagation delay.

The memory 1020, being connected to the processor 1030, includes information for supporting all of the operation of the processor 1030. As one example, the memory 1020 may store information on received reference signal, propagation delay, and time of the obtained reference signal. Also, the memory 1020 may store resource information on the signal of the corresponding UE.

Meanwhile, the network 1050 comprises ab RF unit 1060, a processor 1080, and a memory 1070. The RF unit 1060, being connected to the processor 1080, transmits/receives a radio signal. At this time, the network may be formed so that a part of entities of the eNB and a part of entities of an upper core network are partially supported according to the operation. In other words, the processor 1080 of the network according to the present invention is an entity performing a function, procedure, and method according to the present invention, which performs the operation of FIGS. 2 to 9.

In other words, the processor 1080 performs resource allocation by taking account of capability information, service state, and channel state of the UEs within a cell. In particular, the processor 1080 may allocate resources for D2D communication according to the present invention. To prevent inter-symbol interference due to a difference of TA of the respective UEs, the processor 1080 may allocate allocation information and offset information about each resource block, which is determined for each UE. Therefore, the processor 1080 may obtain a reference signal for a D2D UE pair for each UE and service in a proper manner and may control an allocation location of each signal so that actual D2D communication can be performed through the obtained reference signal. Also, the processor 1080 may notify of configuration about power and modulation scheme for D2D uplink symbols with respect to an arbitrary area for D2D communication. Furthermore, the processor 1080 may set up a transmission period of D2D uplink symbols. Similarly, the processor 1080, by providing information about allocation between the cellular communication symbol and D2D communication symbols, may help the UE predict an allocation rule.

In other words, the network 1050 may make the UE obtain information on a time period and resources required for signal transmission of a corresponding UE, predict transmission time of the signal transmission by using the information on the time period and resources, compare the predicted transmission time with reception time of a signal transmitted from an actual corresponding UE, and transmit parameters to check propagation delay. The network 1050 may provide information to determine whether to perform D2D communication by comparing the checked propagation delay with predetermined reference values for conversion to D2D communication. At this time, determining whether to perform D2D communication may include determining conversion to D2D communication by taking account of a channel state of a received signal. Also, the network 1050 may perform the determination operation by using channel state information received from the UE and commands conversion to D2D communication based on the determination operation.

The memory 1070, being connected to the processor 1080, includes information for supporting all of the operations of the processor 1080.

The descriptions above are only illustration of the technical principles of the present invention, and it should be noted by those skilled in the art to which the present invention belongs that various modifications and changes are possible without departing from the inherent characteristics of the present invention. Therefore, the embodiments disclosed in this document are not intended to limit the technical principles of the present invention but are intended for description thereof. And the technical scope of the present invention is not limited by the embodiments. The technical scope of the present invention should be interpreted by the appended claims, and it should be understood that all of the technical principles falling within the range equivalent thereto are included in the technical scope of the present invention defined by the appended claims.

What is claimed is:

1. A method for supporting device-to-device (D2D) communication in a wireless communication system, the method comprising:
receiving a request message, which includes time information and resource information with respect to a signal of a corresponding user equipment (UE), for D2D communication from a network;
estimating a channel state with respect to the signal of the corresponding UE by using the time information and the resource information;
determining availability of D2D communication by taking account of the channel state; and
transmitting a response message which includes indication information on the availability of D2D communication to the network.

2. The method of claim 1, further comprising:
after transmitting the response message, receiving from the network a D2D communication conversion signal which includes time information, resource information, and identification information about a D2D communication link, which are used for the D2D communication in the corresponding UE.

3. The method of claim 1, wherein the request message includes time information on maximum propagation delay for allowing the D2D communication and a threshold for determining whether to convert to the D2D communication.

4. The method of claim 3, wherein the request message further includes information on signal transmission time of the corresponding UE, information on uplink resources through which the signal is transmitted, and information on a reference signal.

5. The method of claim 1, wherein the response message further includes information on the estimated channel state.

6. The method of claim 1, wherein the determining the availability of D2D communication comprises:
checking transmission time of a reference signal by using information on signal transmission time of the corresponding UE, information on uplink resources through which the signal is transmitted, and information on the reference signal, which are included in the request message;
checking propagation delay by comparing the checked transmission time with reception time of the reference signal transmitted from the corresponding UE; and
comparing the checked propagation delay with a predetermined cyclic prefix (CP).

7. The method of claim 6, wherein the comparing the checked propagation delay with the predetermined CP comprises:
determining that the D2D communication is available if the checked propagation delay is smaller than the CP.

8. The method of claim 7, wherein the CP has an adaptive value by taking account of inter-symbol interference and interference between neighbor cells.

9. A method for supporting device-to-device (D2D) communication in a wireless communication system, the method comprising:
receiving time information for signal transmission of a candidate user equipment (UE), information on uplink resources, and information on a reference signal from a network;
receiving the reference signal transmitted from the candidate UE;
estimating a channel state with respect to the received reference signal;
transmitting information on the estimated channel state to the network; and
receiving from the network a message which includes indication information on availability of D2D communication determined by taking account of the information on the channel state.

10. The method of claim 9, further comprising:
estimating transmission time of the reference signal by using the time information, the information on uplink resources, and the information on the reference signal;
checking propagation delay by comparing the estimated transmission time with reception time of the reference time; and
comparing the checked propagation delay with at least one of a permissible maximum propagation delay for the D2D communication or a predetermined cyclic prefix (CP) for converting to the D2D communication.

11. The method of claim 10, further comprising:
removing the candidate UE from a candidate set for establishing a link for the D2D communication if the checked propagation delay is determined to be larger than the CP.

12. The method of claim 10, wherein the CP has an adaptive value by taking account of inter-symbol interference and interference between neighbor cells.

13. The method of claim 9, further comprising:
comparing the estimated channel with a predetermined channel state reference for converting to the D2D communication.

14. The method of claim 12, wherein the predetermined channel state reference has an adaptive value by taking account of at least one of inter-symbol interference, inter-cell interference, or inter-device interference.

15. An apparatus for supporting device-to-device (D2D) communication in a wireless communication system, the apparatus comprising:
a radio frequency (RF) unit for transmitting or receiving a radio signal; and
a processor, coupled to the RF unit, for determining allocated resource information,
wherein the processor is configured to:
receive a request message, which includes time information and resource information with respect to a signal of a corresponding user equipment (UE), for D2D communication from a network;
estimate a channel state with respect to the signal of the corresponding UE by using the time information and the resource information;
determine availability of D2D communication by taking account of the channel state; and
transmit a response message which includes indication information on the availability of D2D communication to the network.
